(19) United States
(12) Patent Application Publication
(10) Pub. No.: US 2005/0061898 A1
(43) Pub. Date: Mar. 24, 2005

(54) Grinder and dispenser for single-handed use

(76) Inventor: Dave Whitmer, Oxnard, CA (US)

Correspondence Address: LAW OFFICE OF MICHAEL P. EDDY, #510, 2683 VIA DE LA VALLE, SUITE G, DEL MAR, CA, 92014, US

(21) Appl. No.: 10/668,452

(22) Filed: Sep. 22, 2003

(51) Int. Cl. A47J 42/00

(52) U.S. Cl. 241/169.1

(57) ABSTRACT

This invention is a grounding apparatus for single-handed with a housing, a grinding mechanism having a rotary grinding wheel, a driving mechanism having an operating lever directly attached to a rack with a curved locus, a drive shaft coaxially affixed to the grinding wheel and the pinion gear.

### CROSS-REFERENCES TO OTHER RELATED PATENT APPLICATIONS

This application claims the benefit of U.S. Provisional Application No. 60/339,193, filed Sep. 20, 2002.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The invention is a one-handed condiment grinder/dispenser which can be held and operated with one hand, has a natural handshake grip on the lever, smoothly converts alternating motion into oscillating motion, and does not require a lot of energy to use.

### BRIEF SUMMARY OF THE INVENTION

The one-handed condiment grinder/dispenser has a lever that is spring loaded to return to the “open” position when released. To operate, clasp housing with hand, extend fingers to lever, pull lever, causing rack with curved locus to turn pinion gear, transmitting torque to drive shaft, rotating grinding wheel causing selected condiment to be processed. After full compression of lever, release hand pressure letting the lever return to the “open” position. These steps are repeated until a desired amount of condiment is processed. The invention comprises a housing, a grinding mechanism having a rotary grinding wheel, a driving mechanism having an operating lever directly attached to a rack with a curved locus, and a drive shaft coaxially affixed to the grinding wheel and the pinion gear.

### BRIEF DESCRIPTION OF THE SEVERAL VIEWS OF THE DRAWINGS

The above and other objects, advantages and features of the present invention will be more readily apparent from the following description, when read in conjunction with the accompanying drawings wherein:

FIG. 1 is a plan view of a preferred embodiment, and includes a housing (A), a grinding mechanism having a rotary grinding wheel (B), a driving mechanism (C) having an operating level directly attached to the rack (D) with a curved locus, a drive shaft (E) coaxially affixed to the grinding wheel and the pinion gear (F).

FIG. 2 is a side view of a preferred embodiment, showing relative angular displacement of the lever from the axis of rotation.

FIG. 3 is a side view of a preferred embodiment, showing relative angular displacement of the lever from the axis of rotation.

FIG. 4 is a side view of the base and gear of a preferred embodiment, showing the relative angle of motion of the curved locus.

FIG. 5 is a plan view of the rack having a curved locus and radial expansion.

### DETAILED DESCRIPTION OF THE INVENTION

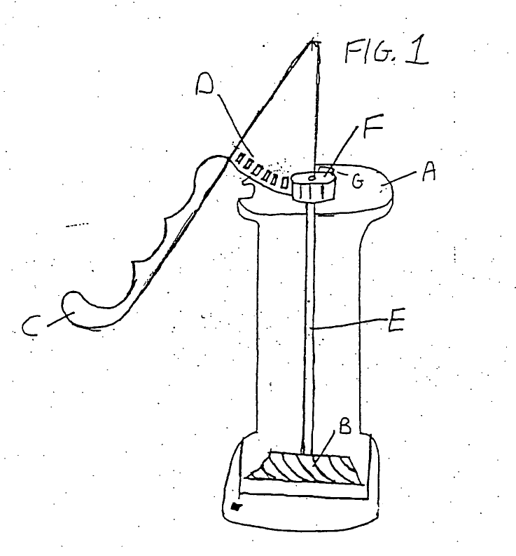

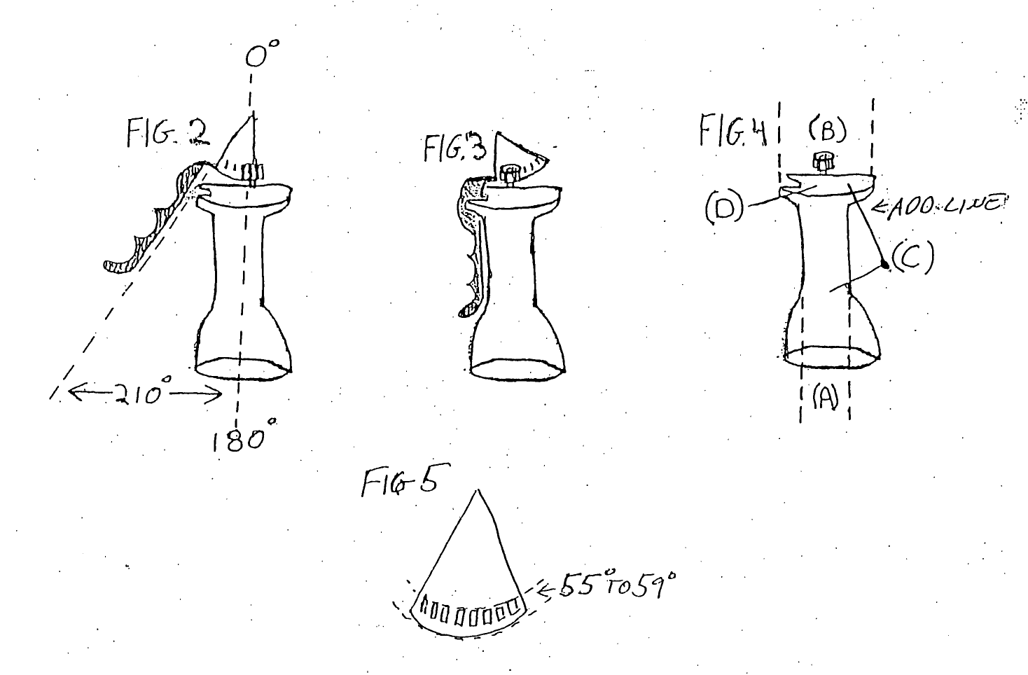

The rack and pinon has a curved locus, involuted gear profile, and may apply up to approximately 25 lbs. P.S.I. to lever. The working rotation can be clockwise (cw) or counterclockwise (ccw) with a 3/16 inch shaft to rotate 180° from start position to full compression. The start position is optimally, in the embodiment shown in FIG. 2, at 210°. The reach comfort is determined by how close the lever is positioned to the body of the mill, and preferably the lever is positioned to the body closer. The pinon gear has a stop shoulder G, as shown in FIG. 1, to abut against the rack to stop further rotation, and control and prevent excessive level travel. As shown in FIG. 3, in full compression, the lever is to fit tight along the body of the pepper mill. It is preferred that the rack travel approximately 1 3/16″, so as to obtain good grinding results while being sized appropriately to fit readily into the average hand size. However, any suitable rack travel distance will suffice for the purposes of the invention and 1″ to 1¼″ will be a preferred range in most circumstances. As shown in FIG. 4, the circumference A at the embodiment's body base is 126 mm, and the internal diameter on the present embodiment is 40 mm. Also as shown in FIG. 4, the circumference B of the drive mechanism base plate can be larger than 126 mm. The location for the grind selector mechanism base plate C, as shown in FIG. 4, is above or below the hand held area. Also in FIG. 4, the fill hole D is located in the base of the drive mechanism. The lever, a bolt-on type apparatus, is preferably separate from the drive mechanism.

As shown in FIG. 5, the radial travel of the curved locus is preferably approximately in the range of 50° to 60°, and most preferably about 55° to 59°. Further, the rack and pinion are preferably milled with an involuted gear profile with the rack having a curved locus. The rack and pinion could also be fabricated by stamping the curved locus from a plate and utilizing a peg gear.

1. A grounding apparatus for single-handed use comprising:
a housing, a grinding mechanism having a rotary grinding wheel, a driving mechanism having an operating lever directly attached to a rack with a curved locus, and a drive shaft coaxially affixed to the grinding wheel and the pinion gear.
